(19) United States
(12) Patent Application Publication
(10) Pub. No.: US 2016/0281875 A1
(43) Pub. Date: Sep. 29, 2016

(54) ROLLOVER VENT VALVE

(71) Applicant: SHAW DEVELOPMENT, LLC, Bonita Springs, FL (US)

(72) Inventors: Peter SUTTON, Naples, FL (US); Michael O'HARA, Naples, FL (US)

(21) Appl. No.: 14/670,666

(22) Filed: Mar. 27, 2015

(51) Int. Cl. F16K 17/36; F16K 1/34; F16K 25/00

(52) U.S. Cl. CPC F16K 17/36; F16K 25/00; F16K 1/34

(57) ABSTRACT

A valve comprising a housing, a flow guide comprising an operational axis, a poppet comprising a sealing surface, a bias weight and a reaction force component engaged with the poppet. In a first orientation, the poppet is open, and in a second orientation, the poppet is closed. The flow guide comprises a first side opposite a second side, and a through hole extending between the sides. The through hole adapted to provide fluid communication through the flow guide. In the open position, the sealing surface is offset from and permits flow through the flow guide. In the closed position, the sealing surface is engaged with and prevents flow through the flow guide. The bias weight may exert an opening bias force on the poppet that is a function of the orientation of the operational axis. The reaction force component may exert a closing bias force on the poppet.

### TECHNICAL FIELD

The present subject matter relates generally to a vent valve, and more particularly to a valve adapted to provide orientation-specific fluid communication therethrough. More particularly, the present subject matter relates to a valve in a liquid storage tank adapted to provide for fluid communication when in a first orientation, but to prevent fluid communication when in a second orientation.

### SUMMARY

The present subject matter generally provides a valve comprising a housing, a flow guide comprising an operational axis, a poppet comprising a sealing surface, a bias weight and a reaction force component engaged with the poppet. In a first orientation, the poppet is open, and in a second orientation, the poppet is closed. The flow guide comprises a first side opposite a second side, and a through hole extending between the sides. The through hole adapted to provide fluid communication through the flow guide. In the open position, the sealing surface is offset from and permits flow through the flow guide. In the closed position, the sealing surface is engaged with and prevents flow through the flow guide. The bias weight may exert an opening bias force on the poppet that is a function of the orientation of the operational axis. The reaction force component may exert a closing bias force on the poppet.

### BRIEF DESCRIPTION OF THE FIGURES

FIG. 1A is an orthogonal section view of a first embodiment in a first orientation of a vent valve according to the present subject matter.

FIG. 1B is an orthogonal section view of a first embodiment in a second orientation of a vent valve according to the present subject matter.

FIG. 1C is an orthogonal section view similar to FIG. 1 in a second orientation where the vent valve is inverted according to the present subject matter.

FIG. 2A is a perspective section view of a second embodiment in a first orientation of a vent valve according to the present subject matter.

FIG. 2B is an orthogonal section view of a second embodiment in a first orientation of a vent valve according to the present subject matter.

FIG. 2C is a close-up section view of the second embodiment of a vent valve according to the present subject matter where the valve is closed.

FIG. 2D is an orthogonal section view of a second embodiment in a first orientation of a vent valve according to the present subject matter.

FIG. 2E is a top perspective view of a second embodiment of a flow guide according to the present subject matter.

FIG. 2F a bottom perspective view of a second embodiment of a flow guide according to the present subject matter.

FIG. 2G is a perspective view of a second embodiment of a guide according to the present subject matter.

FIG. 2H is a perspective view of a second embodiment of a guide according to the present subject matter.

FIG. 3 is a schematic view of a tank and a valve according to the present subject matter.

### DETAILED DESCRIPTION

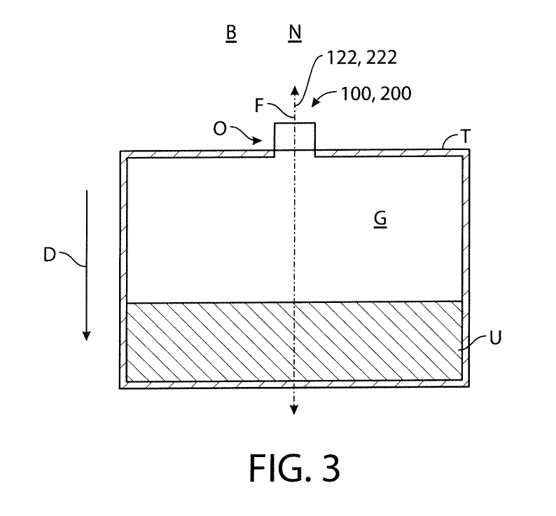

The present subject matter generally relates to a vent valve in a fluid storage tank or other storage structure. For convenience, these structures will simply be referred to as a tank. The following description deals with a tank located in a vehicle, but it could be applied to other applications where changes in orientation of the tank make desirable operation of a valve to prevent the fluid stored in the tank from inadvertently escaping through the vent valve. In the example discussed herein, the vent valve is located in a tank that stores diesel emissions fluid (DEF). DEF is typically an aqueous urea solution (AUS) or the like that is drawn from the tank and injected into an exhaust flow or other diesel emission to react with exhaust gases to reduce nitrous oxide and other emissions. A diagram of one such system is shown in FIG. 3

DEF systems have grown in importance as emissions standards have changed and are common in industrial applications such as large-scale diesel powered earth moving and mining equipment, military vehicles, and tractor trailers. As diesel applications increase in passenger vehicles more vehicles equipped with DEF systems are on the road. Some vent valves for industrial applications include a ball that rests in an open position that allows gas to flow around the ball and out the vent. If the tank is upset to the point of being inverted, the ball rolls to cover the vent opening preventing fluid from escaping through the vent opening. It was observed, however, that seating of the ball in the vent opening was not reliable in positions other than a fully inverted position. For example, a partial vehicle rollover, i.e. on its side or at angle, often resulted in the all not being fully seated over the vent opening allowing stored fluid to leak from the vent. The following subject matter addresses this concern providing a more reliable means for closing the vent during a change in the orientation of the valve.

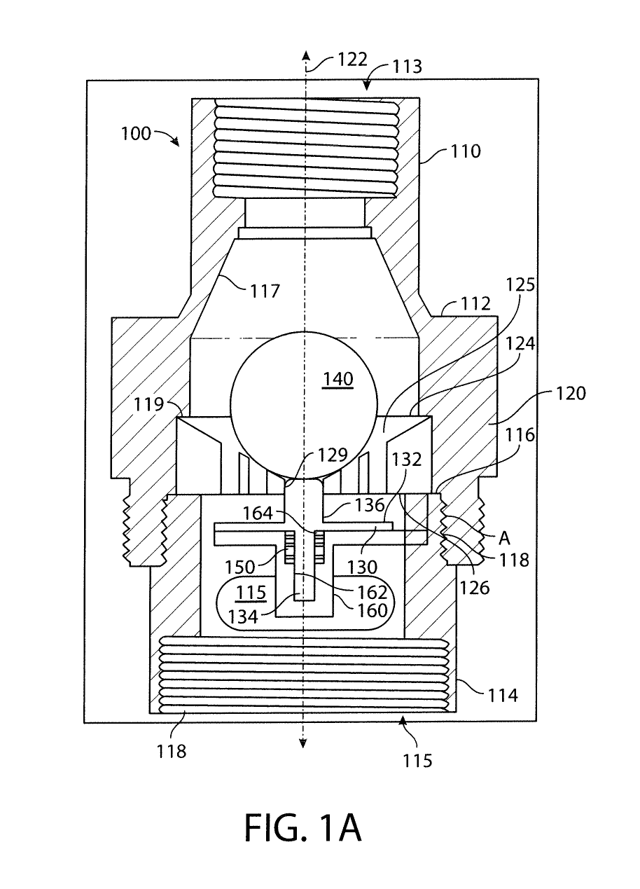

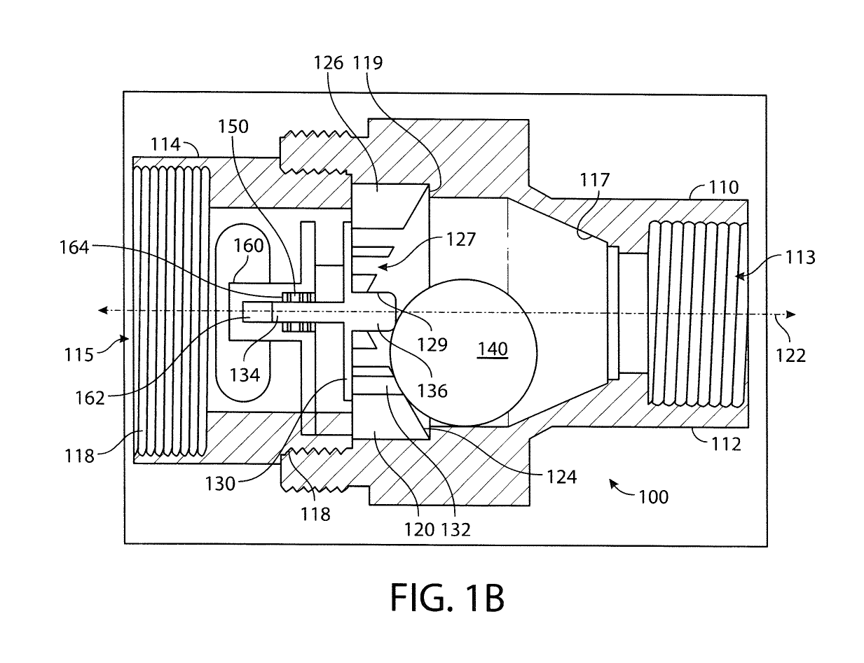

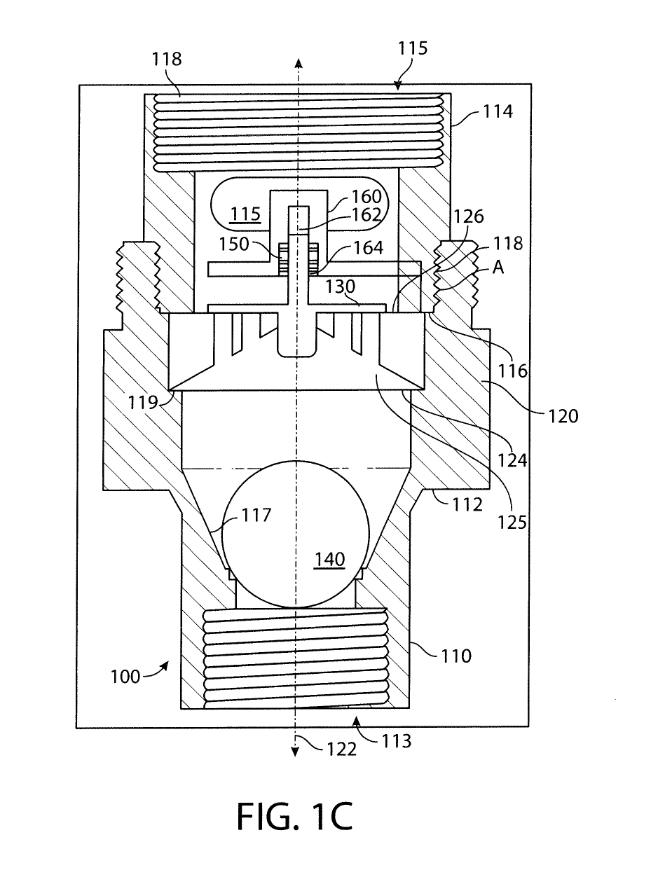

Referring now to FIGS. 1A, 1B, and 3 shown is a first embodiment of a vent valve generally indicated by the number 100. Vent valve 100 includes a housing 110, which may be formed integrally with the tank T or as a separate component that is attached to tank T. For example, housing 110 may be inserted within a vent opening O in tank T. In general, housing 110 defines a flow path, generally indicated by arrow F, for gas G to escape from the tank T to the atmosphere B, or for air N from the atmosphere B to enter the tank T. The first embodiment of a vent valve 100 comprises a housing 110, a flow guide 120, a poppet 130, a bias weight 140, and a reaction force component 150. These components are located within the flow path F to selectively open and close the flow path F based on orientation of the vent valve 100 with respect to the downward direction D. The first embodiment of a vent valve 100 optionally comprises a guide 160. In general, housing 110 houses flow guide 120 with the flow guide 120 effectively dividing the housing 110 into an inlet side and an outlet side. As discussed in more detail below, the flow guide 120 and poppet 130 interact with each other to control the flow of gas and fluid from one side of housing 110 to the other.

Housing 110 may be formed as a single piece or multiple sub-housings or components may be assembled to form housing 110. With continued reference to FIGS. 1A and 1B, housing 110 may comprise a first sub-housing 112 and a second sub-housing 114. The first sub-housing 112 and the second sub-housing 114 may each comprise one or more engagement components 118 to facilitate fluid tight engagement to one or more other components. For example and without limitation, in FIGS. 1A and 1B, first sub-housing 112 and a second sub-housing 114 are threadedly engaged by engagement components 118 to one another at A. It should be understood that there are many acceptable means to facilitate fluid tight engagement, compression fitting, welding, soldering, brazing, mechanical fasteners, adhesives, etc., and that threaded engagement is only one such means. The first sub-housing 112 comprises an outlet aperture 113 allowing fluid to exit first sub-housing 112. The second sub-housing 114 comprises an inlet aperture 115 allowing fluid to enter second sub-housing 114. The housing 110 comprises optional internal engagement features 119, such as, without limitation, shoulders, to locate or facilitate engagement of other components such as, without limitation, the flow guide 120 or guide 160.

In the example shown, internal engagement feature 119 includes a recess portion formed in first sub-housing 112. The recess forms a shoulder spaced axially outward from the engagement component 118 of first sub-housing 112 a distance sized to receive the flow guide 120 between the engagement feature 119 and the engagement component 118. In this example, attachment of second sub-housing 114 attaches at engagement component 118 and includes an end 116 that abuts an end of flow guide 120 to secure it within housing 110.

With continued reference to FIGS. 1A and 1B, flow guide 120 defines a first operational axis 122, a first side 124, a second side 126 opposite the first side 124, and one or more through holes 127. The first side 124 may comprise or define a seat 125 or other locating structure for bias weight 140. A seat 125 may be flat, or may comprise at least one concavity extending over part or all of the seat 125, or other structure adapted to retain the bias weight 140 in the normal operational position shown in FIG. 1A, and to induce a restorative force on the bias weight 140 to return it to the normal operational position if removed from the normal operational position. For example, and without limitation, in FIGS. 1A and 1B, seat 125 comprises a substantially frusto-conical concavity. It should be understood that there are many acceptable geometries for seat 125, planar, semi-ellipsoid, parabolic, hyperbolic, hemispherical, conical, etc., and that substantially frusto-conical is only one such acceptable geometry. The geometry of the seat 125 determines in part how the valve 100 behaves when the orientation of the valve 100 changes. With a more flat, or more shallow, or more slightly sloped concavity, the bias weight 140 will be more sensitive to changes in orientation of the valve 100 from upright, will more readily move away from the normal operational position, and will less readily return to the normal operational position as the valve 100 returns to upright. With a more deep, or sharply sloped concavity, the bias weight 140 will be less sensitive to changes in orientation of the valve 100 from upright, will less readily move away from the normal operational position, and will more readily return to the normal operational position as the valve 100 returns to upright. As will be made more clear herebelow, a valve 100 with seat 125 comprising a more flat or more shallow or more slightly sloped concavity, will change to emergency operational position more readily than would a valve 100 with a more deep or sharply sloped concavity. At least one through hole 127 extends between the second side 126 and the first side 124. The through hole 127 provides fluid communication through the flow guide 120 between the second side 126 and the first side 124. Through hole 127 may be located anywhere on flow guide 120 within the flow path F of housing 110. In the non-limiting embodiments shown in FIGS. 1A and 1B, through hole 127 defines a substantially annular opening formed in flow guide 120. The through hole 127 may take any of a variety of shapes and forms as selected with good engineering judgment. The through hole 127 may comprise one or more separate or interconnected apertures of a shape, circular, semi-circular, or otherwise, chosen with good engineering judgment. The through hole 127 may comprise one or more spokes, or ribs, or other connection elements. The through hole 127 may comprise features to reduce or eliminate resistance to fluid flow such as contoured or rounded or filleted edges or smoothed or dimpled surfaces. In some embodiments, the through hole 127 may be have geometric and dimensional properties chosen to facilitate flow while minimizing or eliminating the likelihood that bias weight 140 will become caught in or on the through hole 127, such as, without limitation, a substantially annular opening or an opening defined by one or more narrow radial slots (not shown). The annular through hole 127 may be radially offset from the center of flow guide 120 by a distance that channels flow of vented or inflowing gas around the bias weight 140 at the normal operational position such that, under normal operational conditions, the bias weight 140 does not substantially interfere with desired fluid communication through the flow guide 120 between the second side 126 and the first side 124.

Flow guide 120 may further comprise an accommodation feature 129. The accommodation feature 129 permits mechanical interaction across the flow guide 120 between the second side 126 and the first side 124. In the non-limiting embodiment shown in FIGS. 1A and 1B, and as will be described further herebelow, the accommodation feature 129 is adapted to permit mechanical interaction between bias weight 140 and poppet 130. It should be understood that the accommodation feature 129 may be a hole of arbitrary shape, circular, polygonal, or otherwise, or other feature adapted to permit mechanical work to be transferred between the second side 126 and the first side 124.

With continued reference to FIGS. 1A and 1B, poppet 130 is movable with respect to flow guide 120 along the first operational axis 122. Poppet 130 comprises a cover portion, comprising sealing surface 132, and a mounting portion, optionally comprising optional stem 134, and an optional boss 136. Generally, the mounting portion interfaces with and is supported by a portion of the housing 110 or other support including, but not limited to the flow guide 120. In the non-limiting embodiment shown in FIGS. 1A and 1B, the mounting portion of the poppet 130 comprises optional stem 134, supported by and slidably engaged with optional guide 160, and optional boss 136, supported by and slidably engaged with flow guide 120. In the non-limiting embodiment shown in FIGS. 1A and 1B, the components of the poppet 130 engaged with optional guide 160 and the flow guide 120, are coaxial with operational axis 122 and are constrained by optional guide 160 and the flow guide 120 to sliding axial movement along operational axis 122 within the flow path F. This sliding axial movement along operational axis 122 within the flow path F moves the sealing surface 132 with respect to flow guide 120 between a first position, an open position, offset from the flow guide 120 and a second position, a closed position, engaged with the flow guide 120. The details of the operation of this sliding axial movement will be explained further herebelow. The cover portion of poppet 130, sealing surface 132, is a projection which extends outwardly from a central portion of the poppet 130 defined by and coincident with stem 134 and boss 136. The first position is an open position in that the sealing surface 132 is offset from the flow guide 120 and the through hole 127, and permits flow through the flow guide 120. The second position, is a closed position in that the sealing surface 132 is engaged with the flow guide 120, covers the through hole 127, and prevents flow through the flow guide 120 of fluid U. In the second position the sealing surface 132 occludes the through hole 127 to prevent fluid communication of fluid U therethrough. In the non-limiting embodiment shown in FIGS. 1A and 1B, the through hole 127 defines a substantially circular perimeter which the sealing surface 132, formed as a circular shaped perimeter, is adapted to cover. It should be understood that sealing surface 132 may extends radially beyond the extent of the through hole 127 or may have another shape, irregular or otherwise. An optional boss 136 may provide a surface to load or otherwise accept work, by the mechanical interaction across the flow guide 120 as noted above, done on the poppet 130. In the non-limiting embodiment shown in FIGS. 1A and 1B, the boss 136 is coincident with axis 122; extends through the accommodation feature 129 of flow guide 120; and, since the boss 136 extends through the accommodation feature 129 of flow guide 120 in some orientations and positions, the boss 136 may be loaded by bias weight 140 such that the load is transferred to poppet 130. In certain embodiments, the optional boss 136 may be adapted to direct the motion of poppet 130. In certain embodiments, such as the non-limiting embodiment shown in FIGS. 1A and 1B, the boss 136 engages the accommodation feature 129 of flow guide 120 such that the engagement between boss 136 and accommodation feature 129 directs the motion of the poppet 130 between the first position and the second position. In the non-limiting embodiment shown in FIGS. 1A and 1B, the engagement between boss 136 and accommodation feature 129 is slidable engagement that directs the motion of the poppet 130 to translate along axis 122.

With continued reference to FIGS. 1A and 1B, the bias weight 140 has some mass, m. Accordingly, the weight, w, of bias weight 140 in Earth's gravity is then, (m)(g). Bias weight 140 is adapted to selectably load the poppet 130, either directly or through one or more intermediary components, based on the orientation of the valve 100. Bias weight 140 is adapted to exert an opening bias force on the poppet 130. By opening bias force, it is meant that the force or load applied promotes moving the poppet 130 into the open position i.e. a position in which the sealing surface 132 is out of engagement with or spaced from flow guide 120 to allow fluid flow between the second side 126 and the first side 124. In the non-limiting embodiment shown in FIG. 1A, in normal operational configuration the boss 136 of poppet 130 extends into accommodation feature 129 and is held approximately flush to the locus where the accommodation feature 129 meets the first side 124 by the weight w of the bias weight 140 acting thereon. When the valve 100 is upright such that axis 122 is parallel to the downward direction, the bias weight 140 will tend to settle into a position atop boss 136 such that the weight, w, of bias weight 140 will load the poppet 130 in a downward direction along the axis 122. The weight, w, of bias weight 140 acting on boss 136 along axis 122 is designed to be sufficient to overcome the closing bias forces, described more fully herebelow, such that the force along axis 122 is sufficient to open or hold open the poppet 130. As the orientation of valve 100 changes with respect to the downward direction, the weight of bias weight 140 will be directed at an angle to axis 122 such that, at most, only a fraction of the weight w of bias weight 140 will be directed along axis 122 and only a fraction of the weight w will load the poppet 130 along axis 122. It should be understood that when axis 122 is at an angle, a, with respect to the downward direction, if the bias weight 140 remains in contact with boss 136, the force exerted by bias weight 140 on boss 136 will be (m)(g)(cosine a). As the angle of orientation of valve 100 increases with respect to the downward direction D, it will eventually reach an angle at which the valve 100 changes from having the components thereof in the normal operational position shown in the non-limiting embodiment of FIG. 1A to having the components thereof in an emergency operation position as shown in the non-limiting embodiment of FIG. 1B. In changing from the normal operational position to the emergency operation position, the bias weight 140 may roll or tumble away from the boss 136 or may be otherwise unable to continue to load the poppet 130 sufficiently to hold it open against the closing bias forces. In switching to the emergency operational position, the poppet 130 slides axially along operational axis 122 under the action of the closing bias forces until it reaches the second position, the closed position, described above and seals the valve 100 against fluid flow. In certain embodiments, the shape of bias weight 140 may be substantially spherical. In certain embodiments, the bias weight 140 is shaped to sealingly engage with surfaces of the first sub-housing 112. As shown in the non-limiting embodiment in FIGS. 1A and 1B, in certain embodiments the first sub-housing 112 comprises bias weight sealing surfaces 117. When the valve 100 is sufficiently offset from its normal operating orientation, such as an inverted orientation (FIG. 1C), the bias weight 140 can roll, fall or otherwise move into contact with the bias weight sealing surfaces 117 to further close the first sub-housing 112 to fluid flow therethrough. This secondary sealing may assist in preventing leakage of DEF in the event that the event causing the inversion prevents the poppet from adequately closing opening 117.

With continued reference to FIGS. 1A and 1B, the reaction force component 150 is adapted to load the poppet 130. Reaction force component 150 is adapted to exert a closing bias force on the poppet 130. By closing bias force, it is meant that the force or load applied promotes moving the poppet 130 into the closed position. In certain embodiments, the load applied by the reaction force component 150 to the poppet 130 depends on the position of the poppet 130 with respect to the flow guide 120, such that the further the sealing surface 132 is from the flow guide 120 the greater the closing bias force exerted by the reaction force component 150 on the poppet 130. It should be understood that the reaction force component 150 may be installed into the valve 100 with a pre-load selected with good engineering judgment. It should be understood that the reaction force component 150 could be any of a variety of components adapted to provide a reaction force to the poppet and could comprise, a coil spring, a gas spring, an elastomeric bushing, or any other component adapted to provide a reaction force to the poppet 130 chosen with good engineering judgment.

With continued reference to FIGS. 1A and 1B, the optional guide 160 is adapted to retain and guide the poppet 130. The optional guide 160 may comprise a guide cavity 162 adapted to receive, slidably engage, and guide stem 134. As shown in the non-limiting embodiment in FIGS. 1A and 1B, stem 134 extends at least partially into guide cavity 162. The guide 160 may also provide a cavity, shoulder, or other surface for reaction force component 150 to push against. As shown in the non-limiting embodiment in FIGS. 1A and 1B, guide 160 is engaged with the second sub-housing 114 and is slidably engaged with poppet 130 such that poppet 130 may translate with respect to guide 160. In certain embodiments, as shown in the non-limiting embodiment in FIGS. 1A and 1B, the guide 160 is substantially fixed with respect to flow guide 120, such that the action of the reaction force component 150 tends to force the poppet 130 in to the closed position against the flow guide 120.

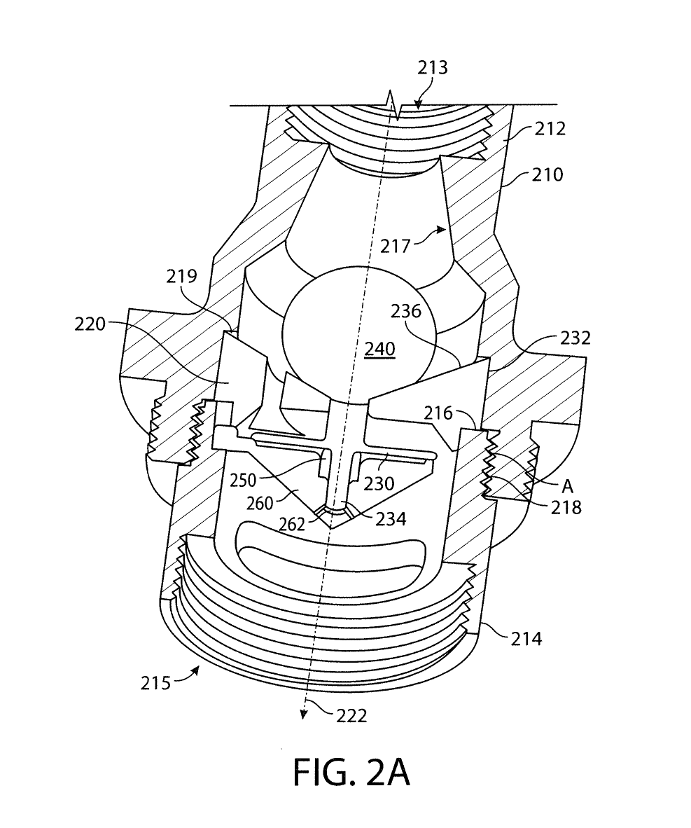

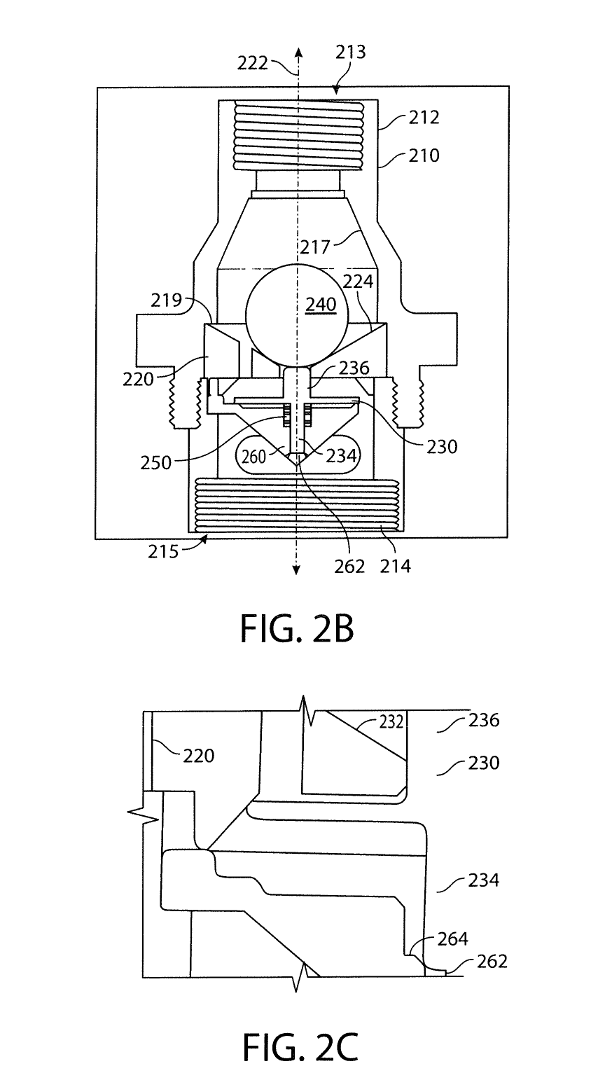

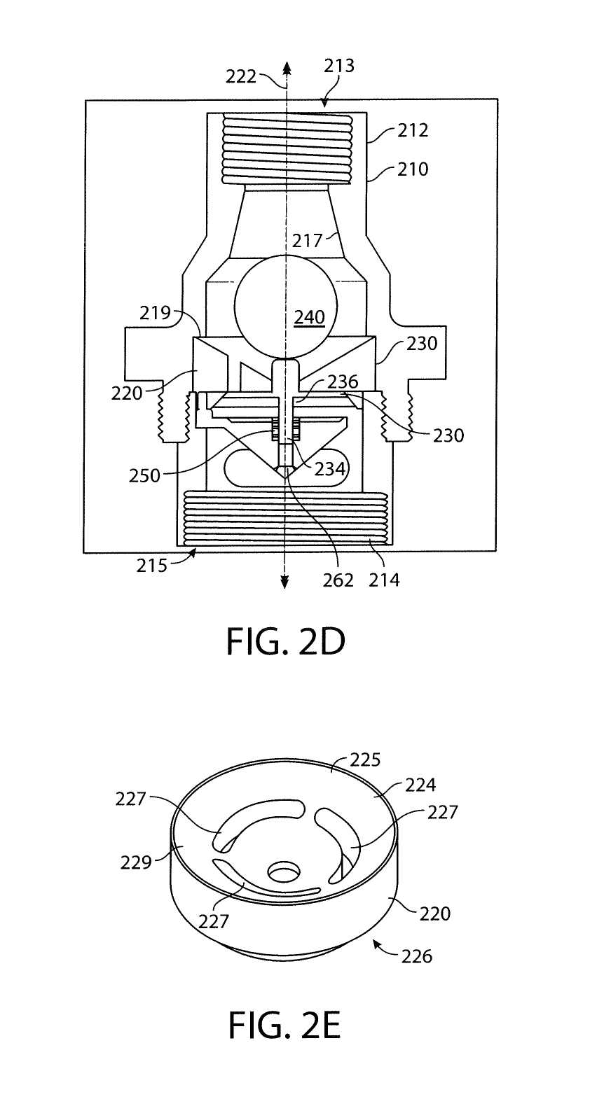

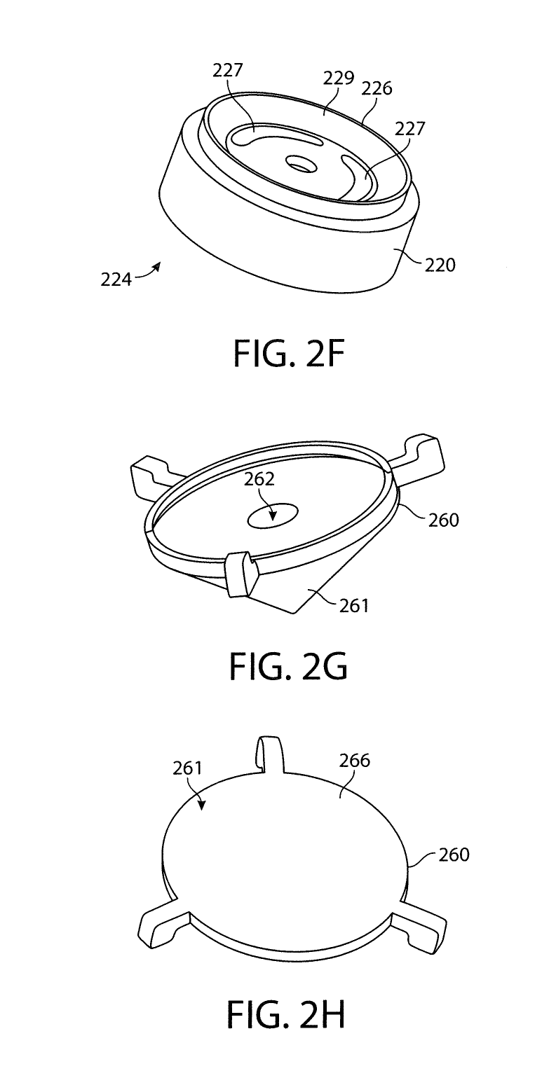

Referring now to FIGS. 2A-2H, and 3 shown is a second embodiment of a vent valve generally indicated by the number 200. Like numbers are used to refer to like components in the first and second embodiments and components in each embodiment may be interchanged or combined. Vent valve 200 includes a housing 210, which may be formed integrally with the tank T or as a separate component that is attached to tank T. For example, housing 210 may be inserted within a vent opening O in tank T. In general, housing 210 defines a flow path, generally indicated by arrow F, for gas G to escape from the tank T to the atmosphere B, or for air N from the atmosphere B to enter the tank T. The second embodiment of a vent valve 200 comprises a housing 210, a flow guide 220, a poppet 230, a bias weight 240, and a reaction force component 250. These components are located within the flow path F to selectively open and close the flow path F based on orientation of the vent valve 200 with respect to the downward direction D. The second embodiment of a vent valve 200 optionally comprises a guide 260. In general, housing 210 houses flow guide 220 with the flow guide 220 effectively dividing the housing 210 into an inlet side and an outlet side. As discussed in more detail below, the flow guide 220 and poppet 230 interact with each other to control the flow of gas and fluid from one side of housing 210 to the other.

Housing 210 may be formed as a single piece or multiple sub-housings or components may be assembled to form housing 210. With continued reference to FIGS. 2A-2H, housing 210 may comprise a first sub-housing 212 and a second sub-housing 214. The first sub-housing 212 and the second sub-housing 214 may each comprise one or more engagement components 218 to facilitate fluid tight engagement to one or more other components. For example and without limitation, in FIGS. 2A-2H, first sub-housing 212 and a second sub-housing 214 are threadedly engaged by engagement components 218 to one another at A. It should be understood that there are many acceptable means to facilitate fluid tight engagement, compression fitting, welding, soldering, brazing, mechanical fasteners, adhesives, etc., and that threaded engagement is only one such means. The first sub-housing 212 comprises an outlet aperture 213 allowing fluid to exit first sub-housing 212. The second sub-housing 214 comprises an inlet aperture 215 allowing fluid to enter second sub-housing 214. The housing 210 comprises optional internal engagement features 219, such as, without limitation, shoulders, to locate or facilitate engagement of other components such as, without limitation, the flow guide 220 or guide 260.

In the example shown, internal engagement feature 219 includes a recess portion formed in first sub-housing 212. The recess forms a shoulder spaced axially outward from the engagement component 218 of first sub-housing 212 a distance sized to receive the flow guide 220 between the engagement feature 219 and engagement component 218. In this example, second sub-housing 214 attaches at engagement component 218 and includes an end 216 that abuts an end of flow guide 220 to secure it within housing 210.

With continued reference to FIGS. 2A-2H, flow guide 220 defines a first operational axis 222, a first side 224, a second side 226 opposite the first side 224, and one or more through holes 227. The first side 224 may comprise or define a seat 225 or other locating structure for bias weight 240. A seat 225 may be flat, or may comprise at least one concavity extending over part or all of the seat 225, or other structure adapted to retain the bias weight 240 in the normal operational position shown in FIGS. 2A-2H, and to induce a restorative force on the bias weight 240 to return it to the normal operational position if removed from the normal operational position. For example, and without limitation, in FIGS. 2A-2H, seat 225 comprises a substantially frusto-conical concavity. It should be understood that there are many acceptable geometries for seat 225, planar, semi-ellipsoid, parabolic, hyperbolic, hemispherical, conical, etc., and that substantially frusto-conical is only one such acceptable geometry. The geometry of the seat 225 determines in part how the valve 200 behaves when the orientation of the valve 200 changes. With a more flat, or more shallow, or more slightly sloped concavity, the bias weight 240 will be more sensitive to changes in orientation of the valve 200 from upright, will more readily move away from the normal operational position, and will less readily return to the normal operational position as the valve 200 returns to upright. With a more deep, or sharply sloped concavity, the bias weight 240 will be less sensitive to changes in orientation of the valve 200 from upright, will less readily move away from the normal operational position, and will more readily return to the normal operational position as the valve 200 returns to upright. As will be made more clear herebelow, a valve 200 with seat 225 comprising a more flat or more shallow or more slightly sloped concavity, will change to emergency operational position more readily than would a valve 200 with a more deep or sharply sloped concavity. At least one through hole 227 extends between the second side 226 and the first side 224. The through hole 227 provides fluid communication through the flow guide 220 between the second side 226 and the first side 224. Through hole 227 may be located anywhere on flow guide 220 within the flow path F of housing 210. In the non-limiting embodiments shown in FIGS. 2A-2H, through hole 227 defines a substantially annular opening formed in flow guide 220. The through hole 227 may take any of a variety of shapes and forms as selected with good engineering judgment. The through hole 227 may comprise one or more separate or interconnected apertures of a shape, circular, semi-circular, or otherwise, chosen with good engineering judgment. The through hole 227 may comprise one or more spokes, or ribs, or other connection elements. The through hole 227 may comprise features to reduce or eliminate resistance to fluid flow such as contoured or rounded or filleted edges or smoothed or dimpled surfaces. In some embodiments, the through hole 227 may be have geometric and dimensional properties chosen to facilitate flow while minimizing or eliminating the likelihood that bias weight 240 will become caught in or on the through hole 227, such as, without limitation, a substantially annular opening or an opening defined by one or more narrow radial slots (not shown). The annular through hole 227 may be radially offset from the center of flow guide 220 by a distance that channels flow of vented or inflowing gas around the bias weight 240 at the normal operational position such that, under normal operational conditions, the bias weight 240 does not substantially interfere with desired fluid communication through the flow guide 220 between the second side 226 and the first side 224.

Flow guide 220 may further comprise an accommodation feature 229. The accommodation feature 229 permits mechanical interaction across the flow guide 220 between the second side 226 and the first side 224. In the non-limiting embodiment shown in FIGS. 2A-2H, and as will be described further herebelow, the accommodation feature 229 is adapted to permit mechanical interaction between bias weight 240 and poppet 230. It should be understood that the accommodation feature 229 may be a hole of arbitrary shape, circular, polygonal, or otherwise, or other feature adapted to permit mechanical work to be transferred between the second side 226 and the first side 224.

With continued reference to FIGS. 2A-2H, poppet 230 is movable with respect to flow guide 220 along the first operational axis 222. Poppet 230 comprises a cover portion comprising sealing surface 232, and a mounting portion, optionally comprising optional stem 234, and an optional boss 236. Generally, the mounting portion interfaces with and is supported by a portion of the housing 210 or other support including, but not limited to the flow guide 220. In the non-limiting embodiment shown in FIGS. 2A-2H, the mounting portion of the poppet 230 comprises optional stem 234, supported by and slidably engaged with optional guide 260, and optional boss 236, supported by and slidably engaged with flow guide 220. In the non-limiting embodiment shown in FIGS. 2A-2H, the components of the poppet 230 engaged with optional guide 260 and the flow guide 220, are coaxial with operation axis 222 and are constrained by optional guide 260 and the flow guide 220 to sliding axial movement along operational axis 222 within the flow path F. This sliding axial movement along operational axis 222 within the flow path F moves the sealing surface 232 with respect to flow guide 220 between a first position, an open position, offset from the flow guide 220 and a second position, a closed position, engaged with the flow guide 220. The details of the operation of this sliding axial movement will be explained further herebelow. The cover portion of poppet 230, sealing surface 232, is a projection which extends outwardly from a central portion of the poppet 230 defined by and coincident with stem 134 and boss 136. The first position is an open position in that the sealing surface 232 is offset from the flow guide 120 and the through hole 127, and permits flow through the flow guide 120. The second position, is a closed position in that the sealing surface 232 is engaged with the flow guide 220, covers the through hole 227, and prevents flow through the flow guide 220 of fluid U. In the second position the sealing surface 232 occludes the through hole 227 to prevent fluid communication of fluid U therethrough. In the non-limiting embodiment shown in FIGS. 2A-2H, the through hole 227 defines a substantially circular perimeter which the sealing surface 232 projection, formed as a circular shaped perimeter, is adapted to cover. It should be understood that sealing surface 232 may extends radially beyond the extent of the through hole 227 or may have another shape, irregular or otherwise. An optional boss 236 may provide a surface to load or otherwise accept work, by the mechanical interaction across the flow guide 120 as noted above, done on the poppet 230. In the non-limiting embodiment shown in FIGS. 2A-2H, the boss 236 is coincident with axis 222; extends through the accommodation feature 229 of flow guide 220; and, since the boss 236 extends through the accommodation feature 229 of flow guide 120 in some orientations and positions, the boss 236 may be loaded by bias weight 240 such that the load is transferred to poppet 230. In certain embodiments, the optional boss 236 may be adapted to direct the motion of poppet 230. In certain embodiments, such as the non-limiting embodiment shown in FIGS. 2A-2H, the boss 236 engages the accommodation feature 229 of flow guide 220 such that the engagement between boss 236 and accommodation feature 229 directs the motion of the poppet 230 between the first position and the second position. In the non-limiting embodiment shown in FIGS. 2A-2H, the engagement between boss 236 and accommodation feature 229 is slidable engagement that directs the motion of the poppet 230 to translate along axis 222.

With continued reference to FIGS. 2A-2H, the bias weight 240 has some mass, m. Accordingly, the weight, w, of bias weight 240 in Earth's gravity is then, (m)(g). Bias weight 240 is adapted to selectably load the poppet 230, either directly or through one or more intermediary components, based on the orientation of the valve 200. Bias weight 240 is adapted to exert an opening bias force on the poppet 230. By opening bias force, it is meant that the force or load applied promotes moving the poppet 230 into the open position i.e. a position in which the sealing surface 132 is out of engagement with or spaced from flow guide 220 to allow fluid flow between the second side 226 and the first side 224. In the non-limiting embodiment shown in FIGS. 2A and 2B, in normal operational configuration the boss 236 of poppet 230 extends into accommodation feature 229 and is held approximately flush to the locus where the accommodation feature 229 meets the first side 224 by the weight w of the bias weight 240 acting thereon. When the valve 200 is upright such that axis 122 is parallel to the downward direction, the bias weight 240 will tend to settle into a position atop boss 236 such that the weight, w, of bias weight 240 will load the poppet 230 in a downward direction along the axis 222. The weight, w, of bias weight 240 acting on boss 236 along axis 222 is designed to be sufficient to overcome the closing bias force, described more fully herebelow, such that the force along axis 222 is sufficient to open or hold open the poppet 230. As the orientation of valve 200 changes with respect to the downward direction, the weight of bias weight 240 will be directed at an angle to axis 222 such that, at most, only a fraction of the weight w of bias weight 240 will be directed along axis 222 and only a fraction of the weight w will load the poppet 230 along axis 222. It should be understood that when axis 222 is at an angle, a, with respect to the downward direction, if the bias weight 240 remains in contact with boss 236, the force exerted by bias weight 240 on boss 236 will be (m)(g)(cosine a). As the angle of orientation of valve 200 increases with respect to the downward direction D, it will eventually reach an angle at which the valve 200 changes from having the components thereof in the normal operational position shown in the non-limiting embodiment of FIGS. 2A and 2B to having the components thereof in an emergency operation position as shown in the non-limiting embodiment of FIG. 2D. In changing from the normal operational position to the emergency operation position, the bias weight 240 may roll or tumble away from the boss 236 or may be otherwise unable to continue to load the poppet 230 sufficiently to hold it open against the closing bias forces. In switching to the emergency operational position, the poppet 230 slides axially along operational axis 222 under the action of the closing bias force until it reaches the second position, the closed position, described above and seals the valve 200 against fluid flow. In certain embodiments, the shape of bias weight 240 may be substantially spherical. In certain embodiments, the bias weight 240 is shaped to sealingly engage with surfaces of the first sub-housing 212. As shown in the non-limiting embodiment in FIGS. 2A-2H, in certain embodiments the first sub-housing 112 comprises bias weight sealing surfaces 217. When the valve 200 is sufficiently offset from its normal operating orientation, such as an inverted orientation, the bias weight 240 can roll, fall or otherwise move into contact with the bias weight sealing surfaces 217 to further close the first sub-housing 212 to fluid flow therethrough. This secondary sealing may assist in preventing leakage of DEF in the event that the event causing the inversion prevents the poppet from adequately closing opening 217.

With continued reference to FIGS. 2A-2H, the reaction force component 250 is adapted to load the poppet 230. Reaction force component 250 is adapted to exert a closing bias force on the poppet 230. By closing bias force, it is meant that the force or load applied promotes moving the poppet 230 into the closed position shown, without limitation in FIG. 2D. In certain embodiments, the load applied by the reaction force component 250 to the poppet 230 depends on the position of the poppet 230 with respect to the flow guide 220, such that the further the sealing surface 232 is from the flow guide 220 the greater the closing bias force exerted by the reaction force component 250 on the poppet 230. It should be understood that the reaction force component 250 may be installed into the valve 200 with a pre-load selected with good engineering judgment. It should be understood that the reaction force component 250 could be any of a variety of components adapted to provide a reaction force to the poppet and could comprise, a coil spring, a gas spring, an elastomeric bushing, or any other component adapted to provide a reaction force to the poppet 230 chosen with good engineering judgment.

With continued reference to FIGS. 2A-2H, the optional guide 260 is adapted to retain and guide the poppet 230. The optional guide 260 may comprise a guide cavity 262 adapted to receive, slidably engage, and guide stem 234. As shown in the non-limiting embodiment in FIGS. 2A-2H, stem 234 may extend at least partially into guide cavity 262. The guide 260 may also provide a cavity, shoulder 264, or other surface for reaction force component 250 to push against. As shown in the non-limiting embodiment in FIGS. 2A-2H, guide 260 is engaged with the second sub-housing 214 and is slidably engaged with poppet 230 such that poppet 230 may translate with respect to guide 260. In certain embodiments, as shown in the non-limiting embodiment in FIGS. 2A-2H, the guide 260 is substantially fixed with respect to flow guide 220, such that the action of the reaction force component 250 tends to force the poppet 230 in to the closed position against the flow guide 220. In certain embodiments the guide 260 may comprise one or more vent holes 266 between guide cavity 262 and the outer surface 261 of guide 260.

Referring now to FIGS. 1A-2H, in normal operation a vent valve 100, 200 will be in substantially an upright orientation where the first operational axis 122, 222 is substantially parallel to the downward direction D and where the bias weight 140, 240 is being directed toward the poppet 130, 230 by the force of gravity. Normal operation may include some deviation from the upright position and may include some dynamic effects such as operation on a slope, positive acceleration, negative acceleration, and variable acceleration (also known as “jerk”). The degree to which deviation from the upright position and inclusion of dynamic effects is normal operation may be chosen with good engineering judgment. In normal operation, the bias weight 140, 240 will be engaged with the poppet 130, 230 directly or indirectly and will exert an opening bias force on the poppet 130, 230. The reaction force component 150, 250 will be engaged with the poppet 130, 230 directly or indirectly and will exert an closing bias force on the poppet 130, 230. In normal operation, the opening bias force on the poppet 130, 230 will be sufficient to hold the poppet 130, 230 in the open position against the closing bias force such that the poppet 130, 230 stays open and the valve 100, 200 is open to fluid communication though the flow guide 120, 220. Such operation of the valve 100, 200 may permit fluid exchange between the interior of the tank T and the atmosphere B through valve 100, 200. For example, gas G that may be build up in tank T may be released to atmosphere B. Likewise, temperature changes may cause the volume of fluid U in the tank T to vary displacing gas G outward through vent valve 100, 200 or drawing air N inward through vent valve 100, 200. Similarly, as fluid U is drawn from the tank T, atmospheric air N may be drawn into the tank T through vent valve 100, 200 to avoid an unwanted vacuum that may collapse the walls of the tank T or interfere with the flow of fluid U.

In an emergency operation a vent valve 100, 200 will substantially deviate from a upright or normal operational orientation in which the bias weight 140, 240 is being directed toward the poppet by the force of gravity. Emergency operation may include operation during partial or complete roll over where the vent valve is sideways or upside-down relative to normal operational orientation or may include some dynamic effects such as operation on a slope, positive acceleration, negative acceleration, and variable acceleration (also known as “jerk”). The degree to which deviation from the upright position and inclusion of dynamic effects is emergency operation may be chosen with good engineering judgment. In one example, the opening bias force ceases to be sufficient to counteract the closing bias force when the angular deviation of the orientation of the valve 100, 200 with respect to the normal operational orientation, i.e. vertical, is equal to or greater than 30 degrees. In another example, the opening bias force ceases to be sufficient to counteract the closing bias force when the angular deviation of the orientation of the valve 100, 200 with respect to the normal operational orientation, i.e. vertical, is equal to or greater than 90 degrees. In these conditions, the opening bias force exerted on the poppet 130, 230 is not sufficient to hold the poppet 130, 230 in the open position against the closing bias force such that the poppet 130, 230 will close and the valve 100, 200 will close to fluid communication though the flow guide 120, 220. Engagement of sealing surface 132, 232 with flow guide 120, 220 under these conditions, closes through hole 127, 227 to prevent fluid U, such as, without limitation, DEF liquid, from escaping the tank T through valve 100, 200. Alternatively or in addition to the above operation, during emergency operation, under some conditions of very great deviation from the upright position, such as, without limitation where the valve 100, 200 is upside-down or close to upside-down, the bias weight 140, 240 may fall or roll or otherwise move into contact with the bias weight sealing surfaces 117, 217 to further close the first sub-housing 112, 212 to fluid flow therethrough. Such operation of the valve 100, 200 may prevent fluid exchange between the interior of the fuel tank and the atmosphere through valve 100, 200.

While the subject matter has been described with reference to certain embodiments, it will be understood by those skilled in the art that various changes may be made and equivalents may be substituted without departing from the scope of the subject matter. In addition, many modifications may be made to adapt a particular situation or material to the teachings of the subject matter without departing from its scope. Therefore, it is intended that the subject matter not be limited to the particular embodiment disclosed, but that the subject matter will include all embodiments falling within the scope of the appended claims.

1. A valve comprising:
a housing;
a flow guide disposed within the housing and having an operational axis, the flow guide comprising
a first side,
a second side opposite said first side, and
a through hole radially offset from the operational axis and extending between said second side and said first side, said through hole being adapted to provide fluid communication through the flow guide;
a poppet movable with respect to the flow guide along the first operational axis between an open position and a closed position, said poppet comprising a sealing surface wherein
in said open position said sealing surface is offset from the flow guide and permits flow through the through hole, and
in said closed position said sealing surface is engaged with the flow guide and prevents flow through the through hole;
a bias weight engagable with said poppet, the bias weight adapted to exert an opening bias force on the poppet, the magnitude of opening bias force exerted on the poppet being a function of the orientation of the operational axis;
a reaction force component engaged with the poppet and adapted to exert a closing bias force on the poppet; and
wherein,
in a first orientation of the operational axis, the poppet is in said open position, and
in a second orientation of the operational axis, the poppet is in said closed position.

2. The valve of claim 1, wherein the through hole is adapted to provide fluid communication between the second side and the first side.

3. The valve of claim 1 further comprising a poppet guide disposed within the housing in fixed relationship with the flow guide;
wherein the poppet further comprises
a stem supported by and slidably engaged with the poppet guide;
a boss supported by and slidably engaged with the flow guide;
wherein the stem and the boss,
are coaxial with the operational axis, and
are constrained to sliding axial movement along the operational axis.

4. The valve of claim 3, wherein the poppet guide is operationally engaged with the reaction force component.

5. The valve of claim 4, wherein the first side of the flow guide comprises a concavity that is substantially frusto-conical, semi-ellipsoid, parabolic, hyperbolic, hemispherical, or conical.

6. The valve of claim 5, wherein the flow guide comprises an accommodation feature adapted to permit transfer of work by mechanical interaction between the bias weight and the poppet.

7. The valve of claim 6, wherein the boss comprises a surface adapted to accept work done on the poppet and extends at least partially into the accommodation feature.

8. The valve of claim 7, wherein, in a first orientation of the operational axis, the bias weight exerts an opening bias force on the boss sufficient to hold the poppet in the open position.

9. The valve of claim 8, wherein, in a second orientation of the operational axis, the reaction force component exerts a closing bias force on the poppet sufficient to close the poppet.

10. The valve of claim 1, wherein the housing comprises a bias weight sealing surface located opposite from the flow guide with respect to the bias weight, wherein when the valve is inverted with respect to the first orientation of the operational axis, the bias weight engages the bias weight sealing surface to close the housing downstream of the flow guide.

11. A method of selectably providing fluid exchange between atmosphere and a tank interior, comprising:
providing a tank defining an interior region;
operationally engaging a valve with the tank, the valve comprising
a housing,
a flow guide disposed within the housing and having an operational axis, the flow guide comprising
a first side,
a second side opposite said first side, and
a through hole radially offset from the operational axis and extending between said second side and said first side, said through hole being adapted to provide fluid communication through the flow guide,
a poppet movable with respect to the flow guide along the first operational axis between an open position and a closed position, said poppet comprising a sealing surface wherein
in said open position said sealing surface is offset from the flow guide and permits flow through the through hole, and
in said closed position said sealing surface is engaged with the flow guide and prevents flow through the through hole,
a bias weight engagable with said poppet, the bias weight adapted to exert an opening bias force on the poppet, the magnitude of opening bias force exerted on the poppet being a function of the orientation of the operational axis,
a reaction force component engaged with the poppet and adapted to exert a closing bias force on the poppet, and
wherein,
in a first orientation of the operational axis, the poppet in said open position, and
in a second orientation of the operational axis, the poppet in said closed position; and
wherein,
the poppet being in said open position, is sufficient to provide fluid exchange between the interior of a fuel tank and atmosphere, and
the poppet being in said closed position, is sufficient to prevent fluid exchange between the interior of a fuel tank and atmosphere.

12. The method of selectably providing fluid exchange between atmosphere and a tank interior of claim 11, wherein the through hole is adapted to provide fluid communication between the second side and the first side.

13. The method of selectably providing fluid exchange between atmosphere and a tank interior of claim 12, the valve further comprising a poppet guide disposed within the housing in fixed relationship with the flow guide; wherein the poppet further comprises
a stem supported by and slidably engaged with the poppet guide;
a boss supported by and slidably engaged with the flow guide;
wherein the stem and the boss,
are coaxial with the operational axis, and
are constrained to sliding axial movement along the operational axis.

14. The method of selectably providing fluid exchange between atmosphere and a tank interior of claim 13, wherein the guide is operationally engaged with the reaction force component.

15. The method of selectably providing fluid exchange between atmosphere and a tank interior of claim 14, wherein the first side of the flow guide comprises a concavity that is substantially frusto-conical, semi-ellipsoid, parabolic, hyperbolic, hemispherical, or conical.

16. The method of selectably providing fluid exchange between atmosphere and a tank interior of claim 15, wherein the flow guide comprises an accommodation feature adapted to permit transfer of work by mechanical interaction between the bias weight and the poppet.

17. The method of selectably providing fluid exchange between atmosphere and a tank interior of claim 16, wherein the boss comprises a surface adapted to accept work done on the poppet and extends at least partially into the accommodation feature.

18. The method of selectably providing fluid exchange between atmosphere and a tank interior of claim 16, wherein
in a first orientation of the operational axis, the bias weight exerts an opening bias force on the boss sufficient to hold the poppet in the open position; and
in a second orientation of the operational axis, the reaction force component exerts a closing bias force on the poppet sufficient to close the poppet.

19. The method of selectably providing fluid exchange between atmosphere and a tank interior of claim 16, wherein the housing comprises bias weight sealing surfaces.

20. A valve comprising:
a housing;
a flow guide disposed within the housing and having an operational axis, the flow guide comprising
a first side comprising a concavity that is substantially frusto-conical, semi-ellipsoid, parabolic, hyperbolic, hemispherical, or conical,
a second side opposite said first side, and
a plurality of through holes radially offset from the operational axis and extending between said second side and said first side, said through holes being adapted to provide fluid communication between the second side and the first side, and
an accommodation feature adapted to permit transfer of work by mechanical interaction between the first side and the second side;
a poppet guide disposed within the housing and in fixed relationship to the second side of the flow guide;
a poppet comprising
a stem supported by and slidably engaged with the poppet guide, the stem being coaxial with the operational axis and constrained to sliding axial movement along the operational axis,
a boss
supported by and slidably engaged with the flow guide,
being coaxial with the operational axis and constrained to sliding axial movement along the operational axis, and
extending at least partially into the accommodation feature and comprising a surface adapted to accept work done on the poppet,
the poppet being movable with respect to the flow guide along the first operational axis between an open position and a closed position, said poppet comprising a sealing surface wherein,
in said open position said sealing surface is offset from the flow guide and permits flow through the through holes, and
in said closed position said sealing surface is engaged with the flow guide and prevents flow through the through holes;
a bias weight engagable with said poppet, the bias weight adapted to exert an opening bias force on the poppet though the surface of the boss adapted to accept work done on the poppet, the magnitude of opening bias force exerted on the poppet being a function of the orientation of the operational axis;
a spring engaged with the poppet and adapted to exert a closing bias force on the poppet;
wherein the guide is operationally engaged with the spring; and
wherein,
in a first orientation of the operational axis, the bias weight exerts an opening bias force on the boss sufficient to hold the poppet in the open position, and
in a second orientation of the operational axis, the spring exerts a closing bias force on the poppet sufficient to close the poppet.

21. The valve of claim 1, further comprising a plurality of through holes offset radially from the operational axis.
